(19) United States
(12) Patent Application Publication
(10) Pub. No.: US 2017/0116587 A1
(43) Pub. Date: Apr. 27, 2017

(54) VENDING MACHINE

(71) Applicant: MiTAC Computing Technology Corporation, Hsinchu (TW)

(72) Inventor: Yi-Ying Chen, Hsinchu (TW)

(73) Assignee: MITAC COMPUTING TECHNOLOGY CORPORATION, Hsinchu (TW)

(21) Appl. No.: 14/921,887

(22) Filed: Oct. 23, 2015

(51) Int. Cl. G06Q 20/18; G07F 17/00; G06F 3/01

(52) U.S. Cl. CPC G06Q 20/18; G06F 3/013; G07F 17/0014

(57) ABSTRACT

A vending machine is configured to sell a variety of products to a consumer. The vending machine includes an output unit, an eye tracking unit which is used to measure a point of gaze of the consumer for generation of a measured output, and a control unit which is coupled electrically to the output unit and the eye tracking unit, and which controls, according to the measured output generated by the eye tracking unit, the output unit to output information associated with the variety of products.

### FIELD

The disclosure relates to a vending machine, more particularly to a vending machine which includes an eye tracking unit.

### BACKGROUND

A vending machine is a machine which sells items to consumers automatically without the presence of a salesperson for performing general sales tasks. After the consumer inserts currency into the vending machine and selects one of the items, the vending machine dispenses the selected one of the items to the consumer for fulfilling this transaction. However, a conventional vending machine is unlike the salesperson who is capable of observing consumer's preference and performing corresponding promotion to the consumer.

### SUMMARY

Therefore, an object of the disclosure is to provide a vending machine which is capable of detecting a point of gaze (where one is looking) of a consumer and which displays information associated with an item at which the consumer looks to stimulate consumer's interest in purchase of the item.

According to the disclosure, the vending machine is configured to sell a variety of products to a consumer. The vending machine includes an output unit, an eye tracking unit which is used to measure a point of gaze of the consumer for generation of a measured output, and a control unit which is coupled electrically to the output unit and the eye tracking unit, and which controls the output unit to output information associated with the variety of products according to the measured output generated by the eye tracking unit.

An effect of the disclosure resides in that, by means of the eye tracking unit which is used to measure a point of gaze of the consumer for generation of a measured output, and by means of the control unit which controls, according to the measured output generated by the eye tracking unit, the output unit to output information associated with the variety of products, the vending machine is capable of adaptive promotion functionality so as to stimulate consumer's interest in purchase of the products.

### BRIEF DESCRIPTION OF THE DRAWINGS

Other features and advantages of the disclosure will become apparent in the following detailed description of an embodiment with reference to the accompanying drawings, of which:

FIG. 1 is a block diagram illustrating an embodiment of a vending machine according to the disclosure;

FIG. 2 is a perspective view illustrating an exemplary appearance of the embodiment of the vending machine of the disclosure;

FIG. 3 is a schematic view of a display unit of this embodiment which displays information of two products in a form of a comparison table;

FIG. 4 and FIG. 5 cooperatively define a flow chart illustrating an exemplary implementation of a control method performed by a control unit of this embodiment of the vending machine according to the disclosure.

### DETAILED DESCRIPTION

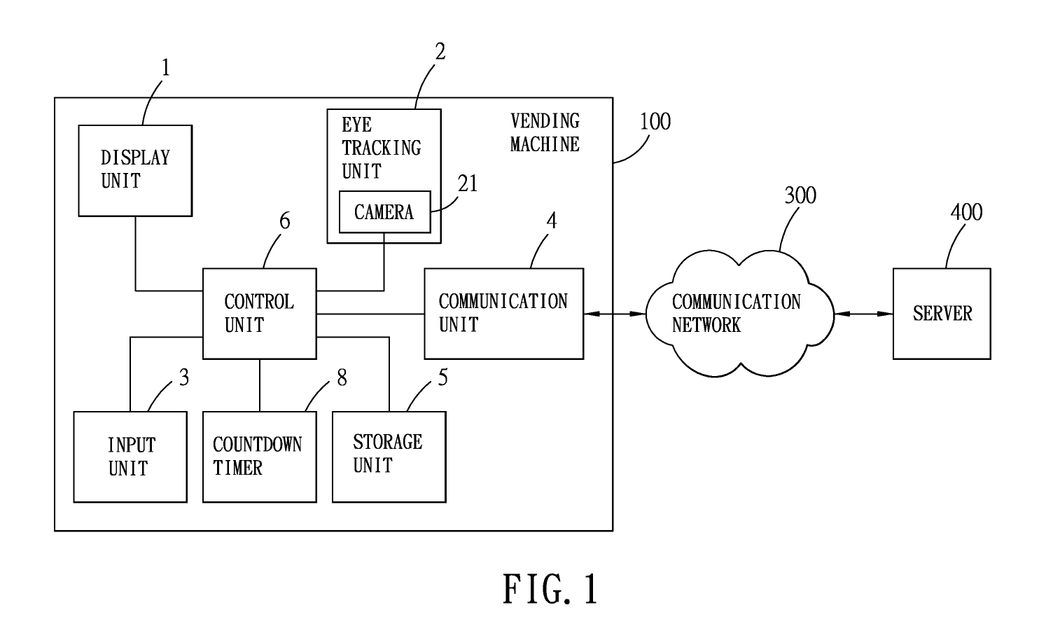

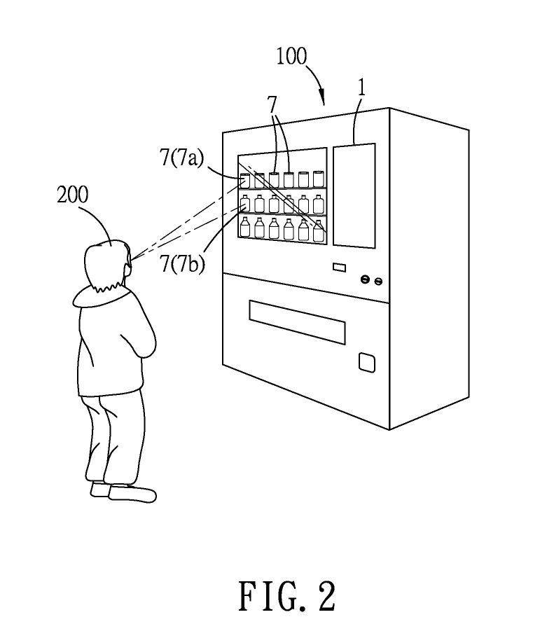

Referring to FIG. 1 and FIG. 2, an embodiment of a vending machine 100 according to the disclosure is configured to sell a variety of products 7 to a consumer 200. The vending machine 100 includes an output unit (e.g., a display unit 1), an eye tracking unit 2, an input unit 3, a communication unit 4, a storage unit 5, a control unit 6 and a countdown timer 8.

The display unit 1 in this embodiment is exemplified as a liquid-crystal display (LCD) unit, but implementation of the display unit 1 is not limited to the disclosure herein. The eye tracking unit 2 is used to measure and determine a point of gaze (i.e., where one is looking by tracking the eye movement of a consumer and simulating a path associated with the eye movement to determine a position substantially matches the path associated with an item or a product displayed on the display unit 1 (or exhibited on the vending machine 100) in order to determine the item or the product that the consumer looks) of the consumer 200 for generating a measured output. The eye tracking unit 2 in this embodiment is an eye tracker, and includes a camera 21.

The eye tracking unit 2 utilizes the camera 21 to record eye positions of the consumer 200 so as to measure and track the eye movement, and a size of the pupil, in order to determine the point of gaze of the consumer 200. The input unit 3 is used for allowing the consumer 200 to input a desired selection from the variety of products and\or the displayed sales promotion. The communication unit 4 is coupled electrically to a communication network 300. The control unit 6 is coupled electrically to the display unit 1, the eye tracking unit 2, the input unit 3, the communication unit 4, the storage unit 5 and the countdown timer 8. The control unit 6 is configured to control, according to the measured output, the display unit 1 to display the information associated with the variety of products 7. More specific operations of the control unit 6 are explained hereinafter.

When the control unit 6 determines, according to the measured output, one of that the point of gaze of the consumer 200 that substantially matches a position and stays at the position associated with one of the variety of products 7 for more than a predetermined time period (also refers to a fixation duration), and that the point of gaze of the consumer 200 that substantially matches a position and has been located at the position associated with said one of the variety of products 7 more than a predetermined number of times (also refers to a fixation count), the control unit 6 according to the measured output controls the display unit 1 to display information associated with said one of the variety of products 7. In this embodiment, the information associated with said one of the variety of products 7 includes at least one of a product introduction, an available stock of said one of the variety of products 7, and a sales promotion of said one of the variety of products 7. Specifically, the control unit 6 controls the display unit 1 to display in sequence the product introduction, the available stock of said one of the variety of products 7, and the sales promotion of said one of the variety of products 7.

The product introduction includes at least one of product specifications, a sales volume and a product review of said one of the variety of products 7. In this embodiment, data associated with product specifications and sales volumes of the variety of products 7 are stored in the storage unit 5, and data of product reviews of the variety of products 7 are stored in a server 400 which is coupled electrically to the communication network 300. The control unit 6 controls the communication unit 4 to receive the product reviews from the server 400 via the communication network 300 for subsequent display by the display unit 1. In this embodiment, the product reviews are displayed in a form of a web page (such as a web page of a shopping website or a blog web page).

The available stock is inventory of said one of the variety of products 7 stored in the vending machine 100 and ready to be sold.

The sales promotion relates to a promotion that is only available for the consumer 200 if a purchase is made during the display of the sales promotion by the display unit 1, that is to say, the promotion lasts for a duration on the display thereof and only applies to a purchase made during this duration through a selection inputted by the consumer 200 via the input unit 3. In this embodiment, when the control unit 6 according to the measured output controls the display unit 1 to display the sales promotion, the control unit 6 further generates an actuating signal to start the countdown timer 8 to count down from a preset time which refers to a time duration of the sales promotion, and maintains the remaining time of the countdown timer in order to control the display unit 1 to simultaneously display the updated countdown information such as the remaining time for the sales promotion before the countdown timer 8 counts down to zero. When the countdown timer 8 counts down to zero, the control unit 6 controls the display unit 1 to stop displaying the sales promotion and the remaining time. In this way, the consumer 200 maybe urged to decide whether to make the purchase before the countdown timer 8 counts down to zero, so that an effect of promotion maybe achieved.

It is noted that, by operations of the control unit 6, when the consumer 200 is interested in one of the variety of products 7 and stares at said one of the variety of products 7, the display unit 1 displays the information associated with said one of the variety of products 7, such that the vending machine 100 may promote products based on the consumer's preferences.

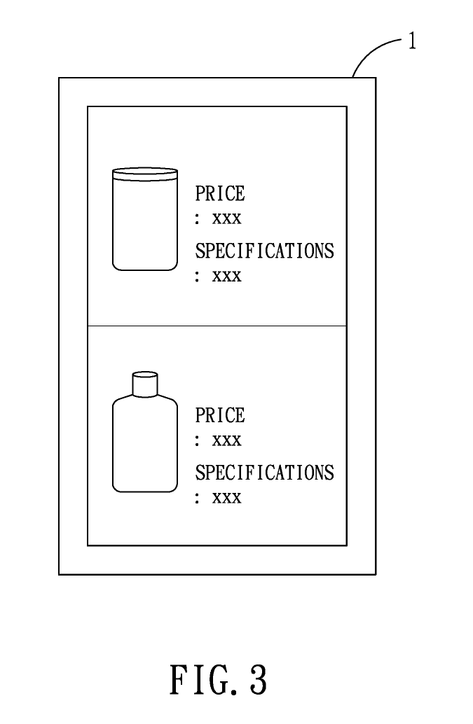

Referring to FIG. 1 to FIG. 3, another operation procedure of the control unit 6 is explained hereinafter. When the control unit 6 determines, according to the measured output, that the point of gaze of the consumer 200 has been substantially located at positions of at least two of the variety of products 7 by turns and has a fixation count associated with each for more than the predetermined number of times, the control unit 6 according to the measured output controls the display unit 1 to display information associated with said at least two of the variety of products 7 at the same time. For example, if the point of gaze of the consumer 200 has been located at positions of a product (7a) and a product (7b) both for more than the predetermined number of times, the control unit 6 controls the display unit 1 to display information associated with the products (7a and 7b) as best shown in FIG. 3. Moreover, the information associated with said at least two of the variety of products 7 displayed by the display unit 1 is presented in a form of a comparison table. In addition, in this case, the display unit 1 displays a plurality of sales promotions each associated with a respective one of said at least two of the variety of products 7, and optionally, a preferential bundle price if said at least two of the variety of products 7 are bought together. In this way, the consumer 200 may be further urged to buy multiple of the variety of products 7 at once. The input unit 3 allows the consumer 200 to select a desired one of the sale promotions (and optionally the preferential bundle price).

It is noted that, by operations of the control unit 6, when the consumer 200 is interested in two of the variety of products 7 and repeatedly stares at said two of the variety of products 7 by turns, the display unit 1 displays the information associated with said two of the variety of products 7 in a manner of the comparison table, such that the consumer 200 may compare these two products with ease.

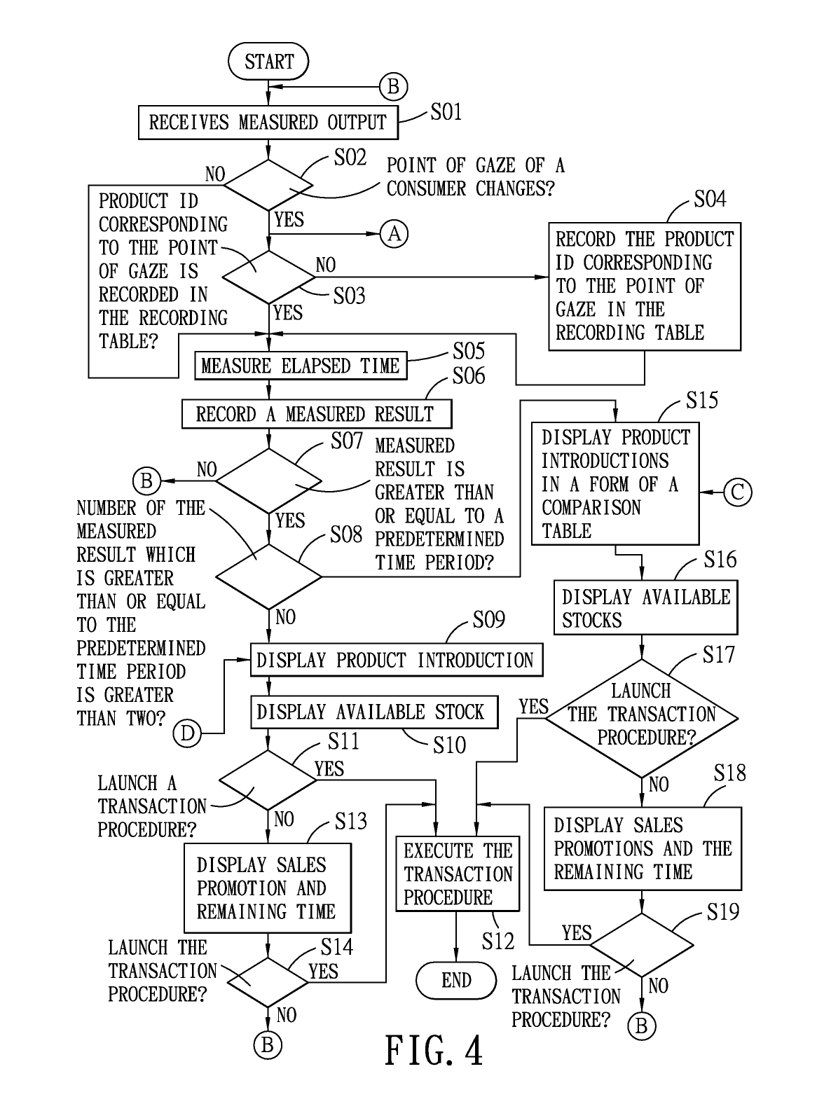

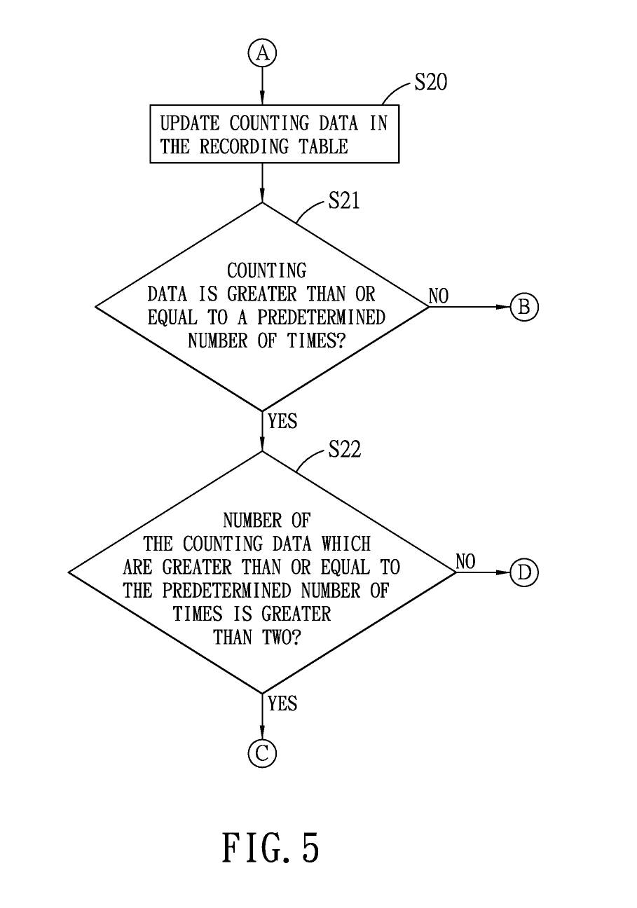

For more explicit explanation of implementation of this embodiment, a control method performed by the control unit 6 of the vending machine 100 is recited hereinafter in combination with FIG. 4 and FIG. 5. It is noted that, the storage unit 5 stores in advance a plurality of product identifications (IDs) corresponding respectively to the variety of products 7. Each of the product IDs corresponds to the product introduction, the available stock, the sales promotion and the position of a respective one of the variety of products 7. The storage unit 5 further stores a recording table.

In step S01, the control unit 6 receives the measured output generated by the eye tracking unit 2 so as to obtain information of the point of gaze of the consumer 200.

In step S02, the control unit 6, according to the updated measured output received in step S01 (hereinafter referred to as a current measured output) and another measured output received right before the current measured output (hereinafter referred to as a previous measured output), determines whether the point of gaze of the consumer 200 changes. When a result of the determination made in step S02 is affirmative, step S03 is performed. Otherwise, step S05 is performed.

In step S03, the control unit 6 determines whether one of the product IDs, which corresponds to the position of one of the variety of products 7 at which the point of gaze of the consumer 200 is located according to the current measured output (hereinafter referred to as a current position), is recorded in the recording table. When a result of the determination made in step S03 is affirmative, step S05 is performed. Otherwise, step S04 is performed.

In step S04, the control unit 6 records said one of the product IDs corresponding to the current position in the recording table, and the flow proceeds to step S05.

In step S05, the control unit 6 begins to measure elapsed time so as to measure duration during which the point of gaze of the consumer 200 stays at the current position.

Subsequently, in step S06, the control unit 6 records a measured result (i.e., a result of the elapsed time thus measured) in the recording table corresponding to an entry of said one of the product IDs.

In step S07, the control unit 6 makes a determination as to whether the measured result recorded in the recording table in step S06 is greater than or equal to the predetermined time period. When a result of the determination made in step S07 is affirmative, step S08 is performed. Otherwise, the flow goes back to step S01.

In step S08, the controller 6 determines whether a number of the measured result which is recorded in the recording table and which is greater than or equal to the predetermined time period is greater than two. When a result of the determination made in step S08 is affirmative, step S15 is performed. Otherwise, step S09 is performed.

In step S09, the control unit 6 controls the display unit 1 to display the product introduction of said one of the variety of products 7 which corresponds to the current position.

In step S10, the control unit 6 controls the display unit 1 to display the available stock of said one of the variety of products 7 which corresponds to the current position.

Subsequently, in step S11, the control unit 6 determines whether an instruction for launching a transaction procedure is received via the input unit 3. When a result of the determination made in step S11 is affirmative, step S12 is performed, in which the control unit 6 executes the transaction procedure for fulfilling the transaction (as is traditionally carried out by a conventional vending machine). Otherwise, step S13 is performed.

In step S13, the control unit 6 controls the display unit 1 to display the sales promotion and the remaining time associated with said one of the variety of products 7 which corresponds to the current position.

Subsequently, in step S14, the control unit 6 determines whether the instruction for launching the transaction procedure is received via the input unit 3. When a result of the determination made in step S14 is affirmative, step S12 is performed, in which the control unit 6 executes the transaction procedure for fulfilling the transaction. Otherwise, the flow goes back to step 501.

When the result of the determination made in step S08 is affirmative, step S15 is performed. In step S15, the control unit 6 controls the display unit 1 to display a plurality of product introductions in a form of the comparison table. Each of the product introductions corresponds to a respective one of the product IDs corresponding to the measured result which is recorded in the recording table and which is greater than or equal to the predetermined time period.

In step S16, the control unit 6 controls the display unit 1 to display a plurality of available stocks, each of which corresponds to a respective one of the product

IDs corresponding to the measured result which is recorded in the recording table and which is greater than or equal to the predetermined time period.

Subsequently, in step S17, the control unit 6 determines whether the instruction for launching the transaction procedure is received via the input unit 3. When a result of the determination made in step S17 is affirmative, step S12 is performed, in which the control unit 6 executes the transaction procedure for fulfilling the transaction. Otherwise, step S18 is performed.

In step S18, the control unit 6 controls the display unit 1 to display a plurality of sales promotions and the remaining time. Each of The sales promotions corresponds to a respective one of the product IDs corresponding to the measured result which is recorded in the recording table and which is greater than or equal to the predetermined time period. Moreover, the sales promotions further include a preferential bundle price if products corresponding to the aforementioned product IDs are bought together.

Subsequently, in step S19, the control unit 6 makes a determination as to whether the instruction for launching the transaction procedure is received via the input unit 3. When a result of the determination made in step S19 is affirmative, step S12 is performed, in which the control unit 6 executes the transaction procedure for fulfilling the transaction. Otherwise, the flow goes back to step 501.

On the other hand, when the result of the determination made in step S02 is affirmative, step S20 is also performed, as well as step S03. In step S20, the control unit 6 updates, in the recording table, counting data which is associated with the number of times that the point of gaze of the consumer 200 has been located at a position of another one of the variety of products 7 at which the point of gaze of the consumer 200 was located according to the previous measured output (referred to as a previous one of the variety of products 7), and which corresponds to a product ID of the previous one of the variety of products 7. Specifically, the counting data is updated by increasing a value thereof by one.

Subsequently, in step S21, the control unit 6 determines whether the counting data thus updated is greater than or equal to the predetermined number of times. When a result of the determination made in step S21 is affirmative, step S22 is performed. Otherwise, the flow goes back to step 501.

In step S22, the control unit 6 makes a determination as to whether a number of the counting data which are recorded in the recording table and which are greater than or equal to the predetermined number of times is greater than two. When a result of the determination made in step S22 is affirmative, step S15 is performed. Otherwise, step S09 is performed.

In summary, by means of the eye tracking unit 2 which measures the point of gaze of the consumer 200 for generation of the measured output and by means of the control unit 6 which controls, according to the measured result, the display unit 1 to display the information associated with the variety of products 7, the vending machine 100 of the disclosure is capable of adaptive promotion functionality for stimulating consumer's interest in purchase of the products.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A vending machine configured to sell a variety of products to a consumer, said vending machine comprising:
an output unit;
an eye tracking unit used to measure a point of gaze of the consumer for generating a measured output; and
a control unit coupled electrically to said output unit and said eye tracking unit, and controlling, according to the measured output generated by said eye tracking unit, said output unit to output information associated with the variety of products.

2. The vending machine of claim 1, wherein said output unit is a display unit; and
when said control unit determines, according to the measured output, that the point of gaze of the consumer stays at a position associated with one of the variety of products for more than a predetermined time period, said control unit according to the measured output controls said display unit to display information associated with said one of the variety of products.

3. The vending machine of claim 2, wherein the information associated with said one of the variety of products includes at least one of a product introduction, an available stock of said one of the variety of products, and a sales promotion associated with said one of the variety of products, the product introduction including at least one of product specifications, a sales volume and a product review of said one of the variety of products.

4. The vending machine of claim 3, wherein said control unit controls, according to the measured output, said display unit to display in sequence the product introduction, the available stock of said one of the variety of products, and the sales promotion associated with said one of the variety of products.

5. The vending machine of claim 3, further comprising a countdown timer coupled electrically to said control unit;
wherein when said control unit according to the measured output controls said display unit to display the sales promotion, said control unit further generates an actuating signal to start said countdown timer to count down from a preset time, and maintains a remaining time of the countdown timer in order to control said display unit to display the updated remaining time before said countdown timer counts down to zero; and
wherein when said countdown timer counts down to zero, said control unit controls said display unit to stop displaying the sales promotion and the remaining time.

6. The vending machine of claim 2, wherein said output unit is a display unit; and
when said control unit determines, according to the measured output, that the point of gaze of the consumer has been located at positions of at least two of the variety of products by turns for more than a predetermined time period, respectively, said control unit according to the measured output controls said display unit to display information associated with said at least two of the variety of products at the same time.

7. The vending machine of claim 6, wherein the information associated with said at least two of the variety of products displayed by the display unit is presented in a form of a comparison table.

8. The vending machine of claim 6, wherein the information associated with said at least two of the variety of products includes at least one of product introductions, available stocks corresponding respectively to said at least two of the variety of products, and sales promotions corresponding respectively to said at least two of the variety of products, the product introduction including at least one of product specifications, sales volume and product reviews corresponding to said at least two of the variety of products.

9. The vending machine of claim 8, wherein said control unit controls, according to the measured output, said display unit to display in sequence the product introductions, the available stocks corresponding respectively to said at least two of the variety of products, and the sales promotions corresponding respectively to said at least two of the variety of products.

10. The vending machine of claim 8, further comprising a countdown timer coupled electrically to said control unit;
wherein when said control unit according to the measured output controls said display unit to display the sales promotions, said control unit further generates an actuating signal to start said countdown timer to count down from a preset time, and maintains a remaining time of the countdown timer in order to control said display unit to display the updated remaining time before said countdown timer counts down to zero; and
when said countdown timer counts down to zero, said control unit controls said display unit to stop displaying the sales promotions and the remaining time.

11. The vending machine of claim 1, wherein said output unit is a display unit; and
when said control unit determines, according to the measured output, that the point of gaze of the consumer has been located at the position of said one of the variety of products more than a predetermined number of times, said control unit according to the measured output controls said display unit to display information associated with said one of the variety of products.

12. The vending machine of claim 11, wherein the information associated with said one of the variety of products includes at least one of a product introduction, an available stock of said one of the variety of products, and a sales promotion associated with said one of the variety of products, the product introduction including at least one of product specifications, a sales volume and a product review of said one of the variety of products.

13. The vending machine of claim 12, wherein said control unit controls, according to the measured output, said display unit to display in sequence the product introduction, the available stock of said one of the variety of products, and the sales promotion associated with said one of the variety of products.

14. The vending machine of claim 12, further comprising a countdown timer coupled electrically to said control unit;
wherein when said control unit according to the measured output controls said display unit to display the sales promotion, said control unit further generates an actuating signal to start said countdown timer to count down from a preset time, and maintains a remaining time of the countdown timer in order to control said display unit to display the updated remaining time before said countdown timer counts down to zero; and
wherein when said countdown timer counts down to zero, said control unit controls said display unit to stop displaying the sales promotion and the remaining time.

15. The vending machine of claim 11, wherein said output unit is a display unit; and
when said control unit determines, according to the measured output, that the point of gaze of the consumer has been located at positions of at least two of the variety of products by turns for more than a predetermined number of times, respectively, said control unit according to the measured output controls said display unit to display information associated with said at least two of the variety of products at the same time.

16. The vending machine of claim 15, wherein the information associated with said at least two of the variety of products displayed by the display unit is presented in a form of a comparison table.

17. The vending machine of claim 15, wherein the information associated with said at least two of the variety of products includes at least one of product introductions, available stocks corresponding respectively to said at least two of the variety of products, and sales promotions corresponding respectively to said at least two of the variety of products, the product introduction including at least one of product specifications, sales volume and product reviews corresponding to said at least two of the variety of products.

18. The vending machine of claim 17, wherein said control unit controls, according to the measured output, said display unit to display in sequence the product introductions, the available stocks corresponding respectively to said at least two of the variety of products, and the sales promotions corresponding respectively to said at least two of the variety of products.

19. The vending machine of claim 17, further comprising a countdown timer coupled electrically to said control unit;
wherein when said control unit according to the measured output controls said display unit to display the sales promotions, said control unit further generates an actuating signal to start said countdown timer to count down from a preset time, and maintains a remaining time of the countdown timer in order to control said display unit to display the updated remaining time before said countdown timer counts down to zero; and
when said countdown timer counts down to zero, said control unit controls said display unit to stop displaying the sales promotions and the remaining time.

20. The vending machine of claim 17, wherein the sales promotions include a preferential bundle price if said at least two of the variety of products are bought together.
